(19) United States
(12) Patent Application Publication
(10) Pub. No.: US 2015/0313696 A1
(43) Pub. Date: Nov. 5, 2015

(54) DENTAL-HYGIENE TOOL

(71) Applicants: Jesse Torres, Kennewick, WA (US); Lucila Torres, Kennewick, WA (US)

(72) Inventors: Jesse Torres, Kennewick, WA (US); Lucila Torres, Kennewick, WA (US)

(21) Appl. No.: 14/703,613

(22) Filed: May 4, 2015

Related U.S. Application Data
(60) Provisional application No. 61/996,308, filed on May 5, 2014.

(51) Int. Cl. A61C 15/04

(52) U.S. Cl. CPC A61C 15/045

(57) ABSTRACT

The current document is directed to a dental-hygiene tool to facilitate flossing of teeth, particularly for orthodontics patients wearing braces or other orthodontic devices, fixtures, and appliances that hinder use of standard dental floss. The currently disclosed dental-hygiene tool includes a hook-shaped tip to which a length of dental floss is attached. The hook-shaped tip has a blunt tip to prevent gum injuries during use and is sufficiently rigid to facilitate navigation through orthodontics fixtures and appliances, including braces.

### CROSS-REFERENCE TO RELATED APPLICATION

This application claims the benefit of Provisional Application No. 61/996,308, filed May 5, 2014.

### TECHNICAL FIELD

The current document is directed to a dental-hygiene tool and, in particular, to a dental-hygiene tool that facilitates teeth cleaning by orthodontics patients wearing braces and other orthodontic devices, fixtures, and appliances that hinder use of standard dental floss.

### BACKGROUND

Braces are a common orthodontic appliance used for straightening teeth. Braces includes brackets, attached to the front sides of teeth, and wires that fit through slots in the brackets in order to apply force to reposition teeth, over time. Braces may also include metal bands, and other components. Although useful in correcting undesirable positions and arrangements of teeth, braces may inhibit proper cleaning and maintenance of teeth, including both brushing and use of dental floss. Regular use of dental floss ameliorates problems such as gingivitis, cavities, tartar, demineralization, and bad breath due to bacteria and other organisms. While a person without braces can generally floss his or her teeth within around two minutes, an orthodontics patient with braces may spend 15 minutes or more to adequately floss his or her teeth.

Numerous different dental-floss threading devices have been developed and proposed to facilitate use of dental floss. However, many of these devices have improper dimensions and shapes for use by orthodontics patients and often require tedious threading operations that are difficult and frustrating for younger children and orthodontics patients lacking adequate near vision and dexterity. For this reason, use of dental floss remains a challenging, tedious, and frustrating endeavor for many orthodontics patients.

### SUMMARY

The current document is directed to a dental-hygiene tool to facilitate flossing of teeth, particularly for orthodontics patients wearing braces or other orthodontic devices, fixtures, and appliances that hinder use of standard dental floss. The currently disclosed dental-hygiene tool includes a hook-shaped tip to which a length of dental floss is attached. The hook-shaped tip has a blunt tip to prevent gum injuries during use and is sufficiently rigid to facilitate navigation through orthodontics fixtures and appliances, including braces.

### BRIEF DESCRIPTION OF THE DRAWINGS

FIG. 1 illustrates one implementation of the dental-hygiene tool to which the current document is directed.

FIGS. 2A-E illustrate an example use of the dental-hygiene tool to which the current document is directed.

FIG. 3 illustrates certain of the dimensions of one implementation of the hook-shaped tip of the currently disclosed dental-hygiene tool.

### DETAILED DESCRIPTION

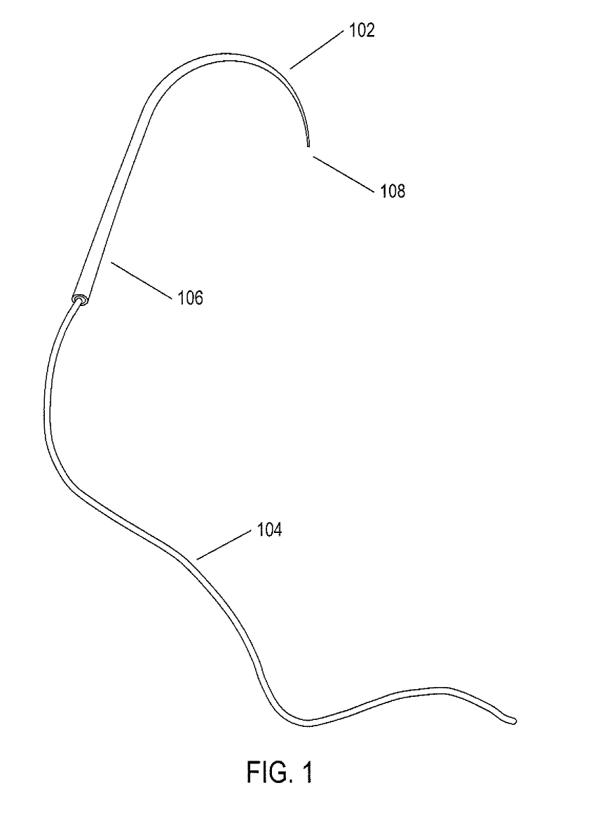

FIG. 1 illustrates one implementation of the dental-hygiene tool to which the current document is directed. The dental-hygiene tool includes a hook-shaped tip 102 within which a length of dental floss 104 is attached. In the implementation illustrated in FIG. 1, the hook-shaped tip includes an inner cylindrical chamber in the handle end 106 into which the length of dental floss is inserted and attached. In the illustrated implementation, the handle end has a diameter of between 0.9 and 1.2 mm and the hook end 108 is a blunt tip with a diameter of 0.4-0.6 mm. In the illustrated implementation, the hook-shaped tip has a linear length of approximately 45 mm and tapers from a point nearer the handle end than the tip end to a point nearer the tip end than the handle end. In certain implementations, the taper maybe be continuous along the length of the hook-shaped tip. In one implementation, the tip is made of high-impact polystyrene and is sufficiently rigid to maintain its shape while manipulated by a user to thread the floss through braces and other orthodontic appliances. In the illustrated implementation, the length of dental floss 104 is attached within the hook-shaped tip by heating to weld the nylon dental floss to the polystyrene material. In other implementations, the dental floss is attached using adhesives within the cylindrical aperture in the handle end of the hook-shaped tip. The dental floss, in the illustrated implementation, is shred-resistant and waxed to facilitate threading of the dental floss between teeth. Because the dental floss is attached internally within the hook-shaped tip, there are no dimensional discontinuities along the surface of the dental-hygiene tool that could catch or become entangled with orthodontic-appliance components, such as wires and brackets.

In alternative embodiments, the hook-shaped tip may be hollow, with dental floss running through the hook-shaped tip and out from the tip end 108. In this implementation, the hook-shaped tip may be advanced along a long stretch of dental floss and excess floss emerging from the tip end can be cut, thus allowing the tip to be continued to be used as worn or soiled dental floss is advanced through the tip and removed in order to a provide a new, fresh stretch of dental floss emerging from the handle end 106. In this implementation, the dental floss is held in place by a secure constriction at the tip end of the hook-shape tip. In yet additional implementations, the hook-shaped tip and dental floss are formed of a continuous material that is differentially molded and/or treated to provide the hook-shaped semi-rigid tip and a trailing, flexible strand of dental floss. In certain implementations, the dental floss is treated with additional substances to confer various desirable properties to the dental floss, including antibacterial properties. In alternative implementations, the hook-shaped tip may have non-circular cross-sections, such as ellipsoid, rectangular, and other cross-section shapes. Similarly, the internal chamber within the hook-shaped tip may have correspondingly differently shaped walls. In these alternative implementations, the term “diameter” refers to a largest dimension perpendicular to the hook-shaped lengthwise axis of the hook-shaped tip.

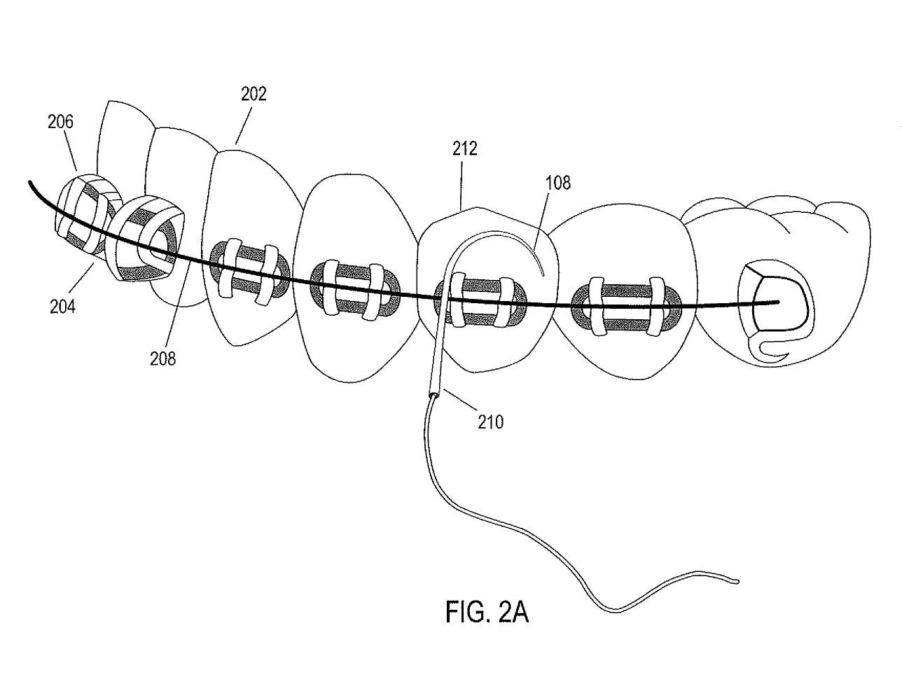

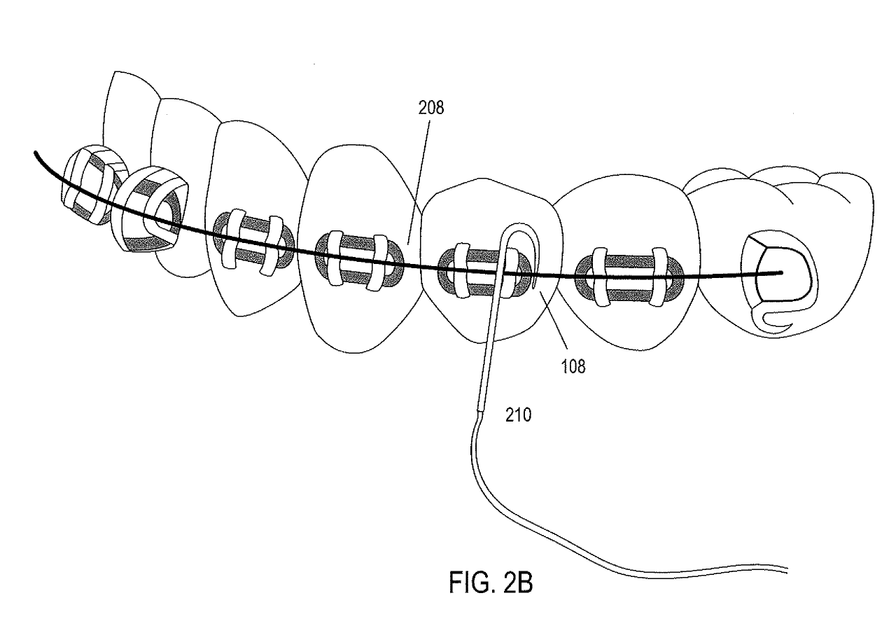

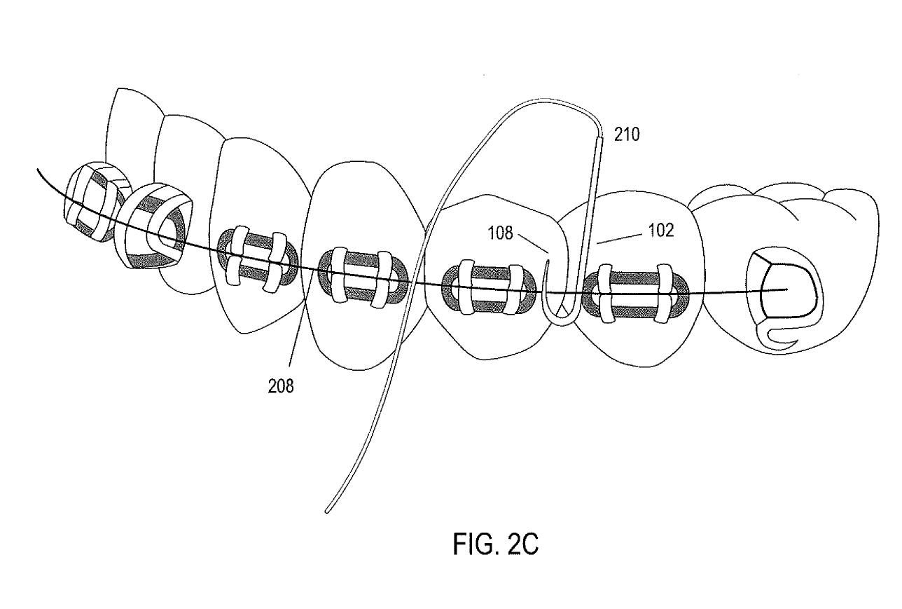

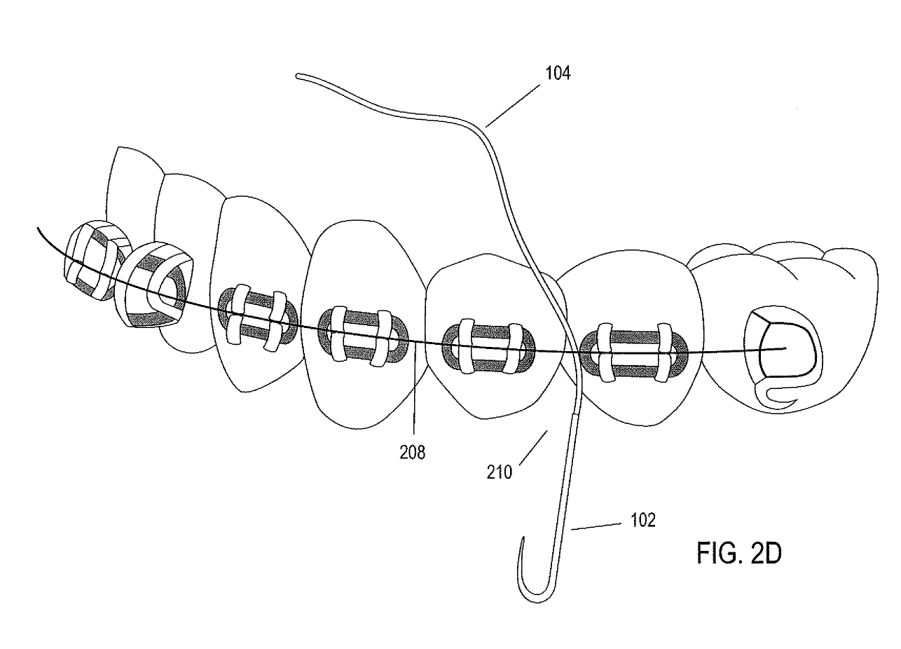

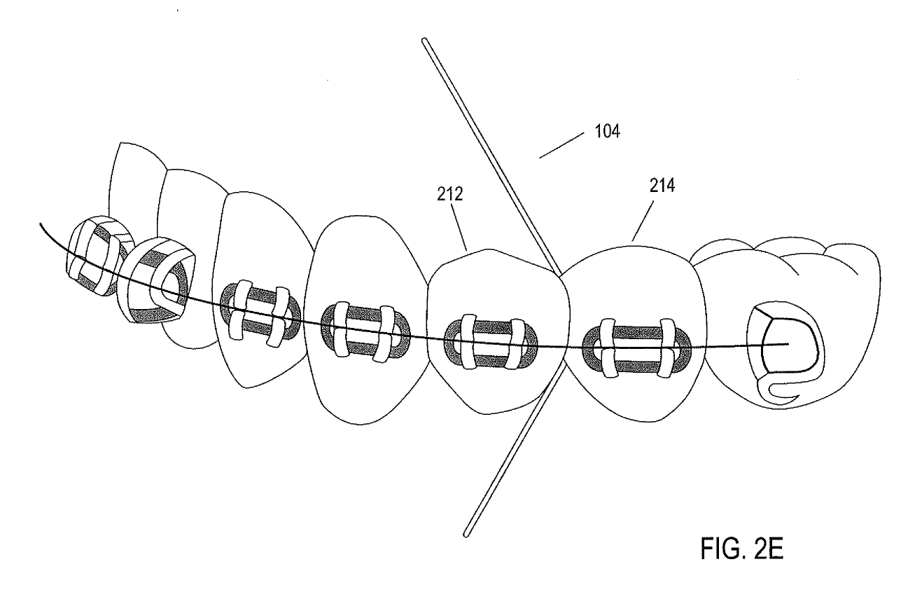

FIGS. 2A-E illustrate an example use of the dental-hygiene tool to which the current document is directed. All five figures use the same illustration conventions, next described with reference to FIG. 2A. In FIG. 2A, a row of teeth 202 is shown, to which an orthodontic brace 204 has been attached. The orthodontic brace 204 includes brackets attached to the face of each tooth, such as bracket 206, and a wire 208 that is slotted through the brackets under tension in order to apply force to the teeth. The dental-hygiene tool to which the current document is directed 210 has been positioned by a user in front of the wire 208 with the tip end 108 resting against the surface of tooth 212. As shown in FIG. 2B, the dental-hygiene tool 210 has been lowered so that the tip end 108 is now positioned below and underneath the wire 208. As shown in FIG. 2C, the hook-shaped tip 102 of the dental-hygiene tool 210 has been rotated upward so that the tip end 108 is now pointed upward and is above the wire 208. As shown in FIG. 2D, the hook-shaped tip 102 of the dental-hygiene tool 210 has been pulled downward to thread the dental floss 104 underneath the wire 208. Finally, as shown in FIG. 2E, the user has now grasped the dental floss with two hands (not shown in FIG. 2E) above and below the wire to pull the dental floss 104 taut and to begin threading the dental floss between tooth 212 and tooth 214 in order to clean the edges of these two teeth and the space between the two teeth at the gum line.

The example manipulation shown in FIGS. 2A-E is but one possible use of the dental-hygiene tool disclosed in the current document. For example, the hook-shaped tip may be alternatively positioned handle-end upward and then rotated downward in order to thread the dental floss upward, below the wire. Many other operations are possible. The various possible operations and manipulations are facilitated by the semi-rigid nature of the hook-shaped tip as well as by the compact, hook-shaped configuration of the hook-shaped tip, allowing large-angle rotations with respect to the teeth and wire without forcing the tip into the teeth or gums. A flaccid, soft tip that does not hold its shape during manipulations would not provide a user with the ability to accurately position and pull the dental hygiene tool through and around spaces between the wire and teeth. Long, needle-like devices cannot be rotated around small components of orthodontic appliances in order to position floss behind them.

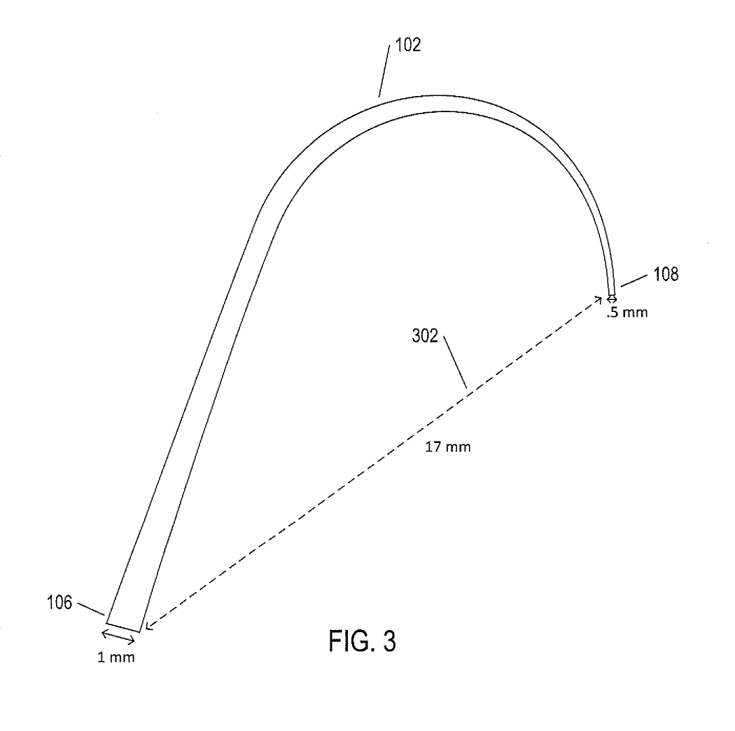

FIG. 3 illustrates certain of the dimensions of one implementation of the hook-shaped tip of the currently disclosed dental-hygiene tool. The hook-shaped tip 102 has a handle end 106 with a diameter of one millimeter and a hook end 108 having a diameter of 0.5 millimeters. The distance between the hook end 108 and the handle end 106 is, in this implementation, 17 mm 302, and may vary from 15 to 19 mm in certain alternative implementations. In the various implementations, the hook-shaped tip has a linear length of between 35 and 55 mm.

Although the present invention has been described in terms of particular embodiments, it is not intended that the invention be limited to these embodiments. Modifications within the spirit of the invention will be apparent to those skilled in the art. For example, any of many different plastic polymers, flexible but semi-rigid metals, or composite materials can be used for the hook-shaped tip in alternative implementations. The dimensions, curvature, and shape of the hook-shaped tip may be varied in order to provide optimal usability for a variety of different types of users and a variety of different types of orthodontic appliances and fixtures.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A dental-hygiene tool comprising:
a semi-rigid hook-shaped tip, having a handle end and a tip end; and
a length of dental floss emanating from the handle end.

2. The dental-hygiene tool of claim 1 wherein the semi-rigid hook-shaped tip has a diameter, at the handle end, greater than the diameter at the tip end.

3. The dental-hygiene tool of claim 1 wherein the semi-rigid hook-shaped tip has a diameter of between 0.9 and 1.2 mm, at the handle end and a diameter at the tip end of between 0.4 and 0.6 mm.

4. The dental-hygiene tool of claim 1 wherein a linear distance from the handle end of the semi-rigid hook-shaped tip and the tip end of the semi-rigid hook-shaped tip is between 15 and 19 mm.

5. The dental-hygiene tool of claim 1 wherein the semi-rigid hook-shaped tip has a length of between 35 and 55 mm.

6. The dental-hygiene tool of claim 1 wherein the semi-rigid hook-shaped tip tapers from a point near the handle end to a point near the tip end.

7. The dental-hygiene tool of claim 1 wherein the length of dental floss is attached to the semi-rigid hook-shaped tip within a chamber formed within the handle end of the semi-rigid hook-shaped tip.

8. The dental-hygiene tool of claim 7 wherein external surface of the semi-rigid hook-shaped tip has a diameter, at the handle end, equal to or greater than the diameter of the length of dental floss, without any bulges or discontinuities from attachment of the length of dental floss to the semi-rigid hook-shaped tip.

9. The dental-hygiene tool of claim 7 wherein the length of dental floss is attached within the chamber formed within the handle end of the semi-rigid hook-shaped tip by heat welding.

10. The dental-hygiene tool of claim 7 wherein the length of dental floss is attached within the chamber formed within the handle end of the semi-rigid hook-shaped tip by as adhesive.

11. The dental-hygiene tool of claim 1 wherein the length of dental floss and the semi-rigid hook-shaped tip are formed from a continuous material that differentially molded and shaped to produce the two different portions.

12. The dental-hygiene tool of claim 1 wherein semi-rigid hook-shaped tip is made from high-impact polystyrene and wherein the length of dental floss is shred-resistant and waxed.

13. The dental-hygiene tool of claim 1 wherein semi-rigid hook-shaped tip is made from one of a polymeric material, a metal, and a composite material.

14. A method employed to clean the teeth of an orthodontics patient wearing braces or other orthodontic devices, fixtures, and appliances that hinder use of standard dental floss, the method comprising:
manipulating a dental-hygiene tool having a semi-rigid hook-shaped tip, with a handle end and a tip end and having a length of dental floss emanating from the handle end to position the length of dental floss between two teeth; and
forcing the dental floss down and up between the two teeth to clean the edges of the teeth and the aperture between the teeth at the gum line.

15. The method of claim 14 wherein the semi-rigid hook-shaped tip has a diameter, at the handle end, greater than the diameter at the tip end.

16. The method of claim 14 wherein a linear distance from the handle end of the semi-rigid hook-shaped tip and the tip end of the semi-rigid hook-shaped tip is between 15 and 19 mm and wherein the semi-rigid hook-shaped tip has a length of between 35 and 55 mm.

17. The method of claim 14 wherein the semi-rigid hook-shaped tip tapers from a point near the handle end to a point near the tip end.

18. The method of claim 14 wherein the length of dental floss is attached to the semi-rigid hook-shaped tip within a chamber formed within the handle end of the semi-rigid hook-shaped tip by one of an adhesive and heat welding.

19. The method of claim 18 wherein external surface of the semi-rigid hook-shaped tip has a diameter, at the handle end, equal to or greater than the diameter of the length of dental floss, without any bulges or discontinuities from attachment of the length of dental floss to the semi-rigid hook-shaped tip.

20. The method of claim 14 wherein the length of dental floss and the semi-rigid hook-shaped tip are formed from a continuous material that differentially molded and shaped to produce the two different portions.
